(19) United States
(12) Patent Application Publication
(10) Pub. No.: US 2026/0080416 A1
(43) Pub. Date: Mar. 19, 2026

(54) Method and device for determining and providing a classification, according to their environmental impact, of a plurality of separate aeronautical flights

(71) Applicant: THALES, Meudon (FR)

(72) Inventors: Maëva ONGALE-OBEYI, TOULOUSE (FR); Clément GONZALEZ, TOULOUSE (FR)

(21) Appl. No.: 19/249,046

(22) Filed: Jun. 25, 2025

(30) Foreign Application Priority Data
Jul. 2, 2024 (FR) 2407182

(51) Int. Cl. G06Q 30/018; G06F 17/11

(52) U.S. Cl. CPC G06Q 30/018; G06F 17/11

(57) ABSTRACT

A method for determining and providing a classification, according to their environmental impact, of a plurality of flights including, for each flight, discretization of the trajectory thereof into a plurality of segments, for each segment, determination of the value of the nitrogen oxide emission index, obtaining the quantity of nitrogen oxides emitted on the segment, obtaining the total quantity of nitrogen oxides, by summing the quantities on each segment, conversion of the total quantity into equivalent carbon dioxide using a predetermined metric and determination of a score of environmental impact, and determination and provision of a classification of the plurality of flights, classified by decreasing value of the score.

### REFERENCE TO RELATED APPLICATION

This application is a U.S. non-provisional application claiming the benefit of French Patent Application No. 24 07182 filed on Jun. 24, 2024, the contents of which are incorporated herein by reference in their entirety.

### TECHNICAL FIELD OF THE INVENTION

The present invention relates to a method for determining and providing a classification, according to the environmental impact thereof, of a plurality of distinct aeronautical flights, the method being implemented by an electronic device.

A further subject matter of the invention relates to a computer program including software instructions which, when executed by a computer, implement such a method.

The present invention also relates to an electronic device for determining and providing a classification, according to the environmental impact thereof, of a plurality of distinct aeronautical flights.

The invention is in the field of aeronautics, and more precisely in the optimization of air operations for the purpose of reducing the associated environmental footprint.

### BACKGROUND OF THE INVENTION

Global warming is a current problem. The radiative forcing of air transport was estimated in 2005 to be nearly 5% of the global anthropogenic radiative forcing (3.5% excluding contrails).

The aviation industry has already made many scientific advances to improve the environmental efficiency of a flight in terms of weight reduction, aerodynamics or propulsion. Despite thereof, emissions from the aviation sector are increasingly important because of traffic growth, which is estimated at more than 3.6% per year.

The optimization of air operations appears as an intermediate means to have beneficial consequences quickly. Indeed, thereof could potentially reduce the sector's carbon footprint by 10% by 2030.

Hitherto, the sector gave a lot of attention to carbon dioxide emissions CO₂, but recent studies have shown that CO₂ is not the only consequence of air operations as non-CO₂ effects account for more than 66% of the sector's radiative forcing.

Indeed, emissions due to fuel combustion can be classified into two categories, on the one hand primary jet fuel combustion products such as carbon dioxide CO₂, water H₂O, sulfur oxides SOx (SO₂, SO₃) which are the direct result of combustion and thus have a constant emission index. Thereof means that the quantity of gas emitted is proportional to the quantity of fuel consumed (the proportionality factor being constant).

On the other hand, the second category corresponds to secondary jet fuel combustion products such as nitrogen oxides NOx (nitrogen oxide NO, nitrogen dioxide NO₂, nitrous oxide, etc.), carbon monoxide CO, HC (unburned hydrocarbons), PM (particular matter) or else VOC (Volatile Organic Compounds) which depend on the nature of the combustion process and the load demanded from the engine. Same thus have an emission index that varies during the flight depending on the type of engine, the engine operating conditions and the atmospheric conditions.

Currently, however, it is very complex to estimate the quantity of nitrogen oxides NOx emitted during a flight. Indeed, there are complex models, such as, e.g., the Boeing Fuel Flow Method 2 (BFFM₂). Such models give access to the EINOx (emission index for NOx) but have the disadvantage of containing a limited number of aircraft.

There are a plurality of studies that aim to reduce the non-CO₂ environmental impact of a flight through trajectory optimization.

However, very often the trajectory optimizations are carried out by focusing on a single type of non-CO₂ emission, such as, e.g., same associated with contrails, whereas non-CO₂ emissions are associated with non-CO₂ effects of several natures, such as aerosol-cloud interactions, aerosol-radiation interactions, stratospheric water vapor, nitrogen oxides, emissions associated with contrails and also with nitrogen oxides being the non-CO₂ emissions having the most significant forcing.

The uncertainties associated with the emissions associated with such effects of distinct natures and the different lifetimes thereof have also led scientific research to study each non-CO₂ effect separately, and there is currently no consensus on the choice of a metric for expressing the impact of each of the emissions associated with the effects of distinct natures.

Moreover, with the current growth in air traffic and the associated operational constraints, it is not relevant nor possible to seek to optimize the trajectory of all flights, all the more since numerous studies have shown that only a small percentage of flights are responsible for the majority of the non-CO₂ emissions of the sector, as non-CO₂ effects are not created uniformly by all flights.

Moreover, current trajectory optimizations often remain theoretical and unachievable, since same are unsuitable to be performed concretely given the operational difficulties generally generated by a change of trajectory (i.e., of flight plan).

### SUMMARY OF THE INVENTION

The goal of the invention is then to propose a solution upstream of the aforementioned trajectory optimization, in order to identify the most judicious flights to be optimized in order to reduce the environmental impact thereof.

To this end, the subject matter of the present invention is a method for determining and providing a classification, according to the environmental impact thereof, of a plurality of distinct aeronautical flights, the method being implemented by an electronic device, and including at least the following operations:
for each flight of the plurality:
   obtaining a previously determined index of nitrogen oxide emission, the index being a discrete variable including, depending upon the engine of the aircraft configured to carry out the flight, four discrete values associated with four distinct phases of flight, respectively, including the take-off, the climb, the approach, the idle;
   from the index, at least by linear regression, obtaining a model of emission of nitrogen oxides, configured to provide the nitrogen oxide emission index associated with each triplet of types of input data including engine thrust, humidity and atmospheric pressure,
   discretization of the trajectory associated with the flight, according to a predetermined constant time step, into a plurality of trajectory segments;
   for each segment:
      determination of a triplet of input data including the engine thrust, the humidity and the atmospheric pressure associated with the segment;
      on the basis of the triplet of input data triplet of the segment and of the model of emission of nitrogen oxides, determination of the associated value of the emission index of nitrogen oxides;
      using a model of predetermined fuel flow, the associated value of the emission index of nitrogen oxides and the time step, obtaining the quantity of nitrogen oxides emitted on the segment;
   obtaining the total quantity of nitrogen oxides emitted on the flight, by summing the quantities of nitrogen oxides emitted on each segment of the plurality of segments composing the trajectory of the flight;
   conversion of the total quantity of nitrogen oxides into equivalent carbon dioxide CO_{2eqNOx} using a predetermined metric of global warming potential;
   at least on the basis of the quantity of equivalent carbon dioxide CO_{2eqNOx} associated with the total quantity of nitrogen oxides emitted on the flight, determination (80) of a score C of environmental impact of the flight;
determination and provision of a classification, according to the environmental impact thereof, of the plurality of distinct aeronautical flights, classified by decreasing value of the score C of environmental impact of each of the flights.

Thereby, the present invention proposes a solution for quantifying the total quantity of nitrogen oxides emitted during each flight and uses such quantity for determining a score of environmental impact making possible the comparison and the classification of a plurality of flights according to the environmental impact thereof, and hence the identification of the most problematic flights at least in terms of emission of nitrogen oxides.

In addition, the conversion carried out into an equivalent quantity of carbon dioxide makes possible a comparison and/or a combination to the quantification of other effects contributing to radiative forcing also expressed as an equivalent quantity of carbon dioxide, i.e., on the scale of carbon dioxide CO₂.

In other words, the proposed impact score is a reliable indicator that identifies problematic flights for which it is appropriate to modify the trajectory.

Thereby, the present invention proposes a generic method which makes it possible to consider, at least the emissions notCO₂ due to nitrogen oxide emissions, as being equal to the CO₂ emissions, and falls upstream of the trajectory optimization as such because the invention aims beforehand to estimate whether a flight is problematic with respect to non-CO₂ emissions (by assigning thereto a coefficient expressed subsequently), i.e., whether it is judicious to set up the trajectory optimization or if it is preferable to focus on another flight.

According to other advantageous aspects of the invention, the method for determining and providing a classification, according to the environmental impact thereof, includes one or a plurality of the following features, taken individually or according to all technically possible combinations:
the predetermined global warming potential metric is GWP100;
the triplet of input data of the segment is determined from a set (63) of priorly determined test data;
the method further includes, for each flight of the plurality, the determination of the equivalent carbon dioxide impact associated with at least one persistent contrail of the flight, and taking same into account for determining the score of environmental impact of the flight;
the determination of the equivalent carbon dioxide impact associated with at least one persistent contrail of the flight includes:
   obtaining, at the input, a mapping of the geographical zones of formation of persistent contrails of the flight;
   the superposition of the mapping with the trajectory of the flight and determination of the length of persistent contrail(s) likely to be generated during the flight;
   obtaining the equivalent quantity of carbon dioxide CO_{2eq contrails} associated with at least one length of persistent contrail of the flight.
the score C of environmental impact of each of the flights also takes into account at least one of the following coefficients:
   a coefficient coeff_{ATC} representative of the difficulty of modifying the flight from the point of view of air traffic control;
   a coefficient coeffₐᵢᵣₗᵢₙₑ representative of the difficulty of modifying the flight from the point of view of the airline associated with the flight;
the score C is obtained by using an equation in the following form:

$$C = ( \frac{{CO}_{2 eq contrails} + {CO}_{2 eq NOx}}{{CO}_{2 eq ref citypairs}} ) * {coeff}_{ATC} * {coeff}_{airline}$$

where CO_{2eq ref citypairs} is the average of the non-CO₂ environmental impact, in terms of nitrogen oxide emissions and persistent contrail(s), of flights for each pair formed by the airport of departure and the airport of arrival of the flight;
the score C also takes into account the CO₂ emissions associated with the flight using an equation in the following form:

$$C = ( \frac{{CO}_{2} + {CO}_{2 eq contrails} + {CO}_{2 eq NOx}}{{CO}_{2 ref citypairs} + {CO}_{2 eq ref citypairs}} ) * {coeff}_{ATC} * {coeff}_{airline}$$

where CO_{2 ref citypairs} is the average of the environmental impact CO₂ of the flights for each pair formed by the airport of departure and the airport of arrival of the flight;
the method further includes, for each flight, or for a predetermined number of flights of the top classification, an operation of identification (102) of the segment or segments of the trajectory having the maximum quantity or quantities of non-CO₂ emission or having the maximum quantity or quantities of CO₂ and non-CO₂ emission;

The invention further relates to a computer program including software instructions which, when executed by a computer, implement the operations of the aforementioned method for determining and providing a classification, according to the environmental impact thereof, of a plurality of distinct aeronautical flights.

The invention further relates to an electronic device for determining and providing a classification, according to the environmental impact thereof, of a plurality of distinct aeronautical flights, the device including at least:
for each flight of the plurality:
   a first obtaining module configured to obtain a previously determined index of nitrogen oxide emission, the index being a discrete variable including, depending upon the engine of the aircraft configured to carry out the flight, four discrete values associated with four distinct phases of flight, respectively, including the take-off, the climb, the approach, the idle;
   a second obtaining module configured to obtain, from the index, at least by linear regression, obtaining a model of emission of nitrogen oxides, configured to provide the nitrogen oxide emission index associated with each triplet of types of input data including engine thrust, humidity and atmospheric pressure,
   a discretization module configured to discretize the trajectory associated with the flight, according to a predetermined constant time step, into a plurality of trajectory segments;
   a first determination module configured to determine, for each segment, a triplet of input data including the engine thrust, the humidity and the atmospheric pressure associated with the segment;
   a second determination module configured to determine, for each segment, on the basis of the triplet of input data triplet of the segment and of the model of emission of nitrogen oxides, the associated value of the emission index of nitrogen oxides;
   a third generation module configured to obtain, for each segment, the quantity of nitrogen oxides emitted on the segment, using a model of predetermined fuel flow, the associated value of emission index of nitrogen oxides and the time step;
   a fourth obtaining module configured to obtain the total quantity of nitrogen oxides emitted on the flight, by summing the quantities of nitrogen oxides emitted on each segment of the plurality of segments composing the trajectory of the flight;
   a conversion module configured to convert the total quantity of nitrogen oxides to equivalent carbon dioxide CO_{2eqNox} using a predetermined global warming potential metric;
   a third determination module configured to determine, at least on the basis of the quantity of equivalent carbon dioxide CO_{2egNox} associated with the total quantity of nitrogen oxides emitted on the flight, a score C of environmental impact of the flight;
a fourth determination module configured to determine and provide a classification, according to the environmental impact thereof, of the plurality of distinct aeronautical flights, classified by decreasing value of the score C of environmental impact of each of the flights.

### BRIEF DESCRIPTION OF THE DRAWINGS

The invention will be clearer upon reading the following description, given only as an example, but not limited to, and making reference to the drawings wherein:

FIG. 1 is a schematic representation of an electronic device for determining and providing a classification, according to the environmental impact thereof, of a plurality of distinct aeronautical flights, according to the present invention;

FIG. 2 is a flowchart of the main operations of a method for determining and providing a classification, according to the environmental impact thereof, of a plurality of distinct aeronautical flights, according to the present invention; and

FIG. 3 illustrates the evolution of the coefficient representative of the difficulty of modifying a flight from the point of view of air traffic control depending upon traffic density.

### DETAILED DESCRIPTION OF THE INVENTION

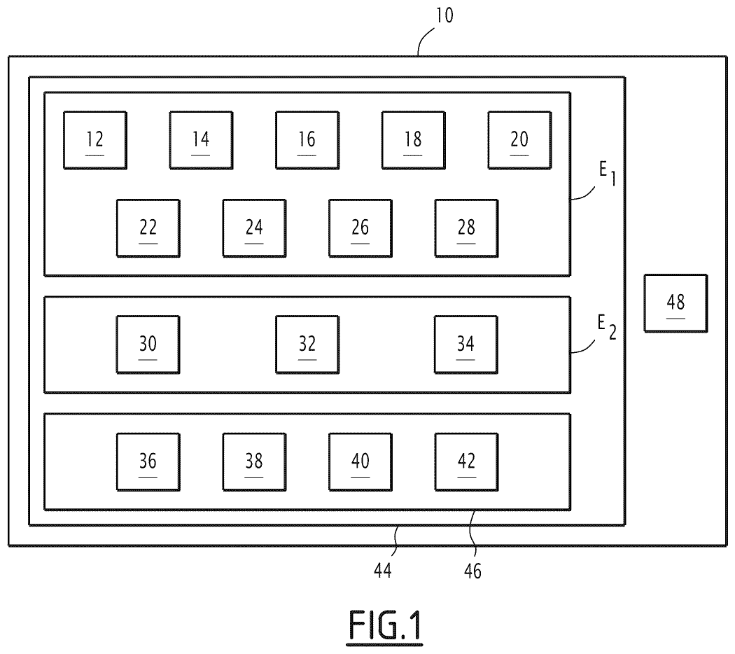

FIG. 1 illustrates an embodiment of an electronic device 10 for determining and providing a classification, according to the environmental impact thereof, of a plurality of distinct aeronautical flights, according to the present invention.

The electronic device 10 for determining and providing a classification, according to the environmental impact thereof, of a plurality of distinct aeronautical flights includes, firstly, a first assembly E₁ of modules for processing each flight in order to determine the equivalent quantity of carbon dioxide CO_{2eqNOx}associated with the total quantity of nitrogen oxides emitted on each of the flights.

More precisely, the first assembly E; includes a first obtaining module 12 configured to obtain a previously determined emission index of nitrogen oxides, the index being a discrete variable including, depending upon the engine of the aircraft apt to perform the flight, four discrete values associated with four distinct phases of flight, respectively, including the take-off, the climb, the approach and the idle.

The first assembly E₁ further includes, for processing each flight, a second obtaining module 14 configured to obtain, from the at least by linear regression, obtaining a model of emission of nitrogen oxides, configured to provide the nitrogen oxide emission index associated with each triplet of types of input data including engine thrust, humidity and atmospheric pressure.

Furthermore, the first assembly E; includes, for processing each flight, a discretization module 16 configured to discretize the trajectory associated with the flight, according to a predetermined constant time step, into a plurality of trajectory segments.

The first assembly E further includes a first determination module 18 configured to determine, for each segment, a triplet of input data including the engine thrust, the humidity and the atmospheric pressure associated with the segment.

The first assembly E₁ further includes a second determination module 20 configured to determine, for each segment, on the basis of the triplet of input data triplet of the segment and of the model of emission of nitrogen oxides, the associated value of the emission index of nitrogen oxides.

The first assembly E₁ further includes a third obtaining module 22 configured to obtain, for each segment, the quantity of nitrogen oxides emitted on the segment, using a model of predetermined fuel flow, the associated value of emission index of nitrogen oxides and the time step.

The first assembly E₁ further includes a fourth obtaining module 24 configured to obtain the total quantity of nitrogen oxides emitted on the flight, by summing the quantities of nitrogen oxides emitted on each segment of the plurality of segments composing the trajectory of the flight.

The first assembly E₁ further includes a conversion module 26 configured to convert the total quantity of nitrogen oxides into an equivalent quantity of carbon dioxideCO_{2eqNOx}, using a predetermined global warming potential (GWP) metric.

The first assembly E₁ also includes a third determination module 28 configured to determine, at least from the equivalent quantity of carbon dioxide CO_{2eqNOx}associated with the total quantity of nitrogen oxides emitted on each flight, a score C of environmental impact of the flight.

As illustrated in FIG. 1, as an optional addition, the electronic device 10 for determining and providing a classification, according to the environmental impact thereof, of a plurality of distinct aeronautical flights also includes a second assembly E₂ of modules for determining, for each flight of the plurality, the equivalent carbon dioxide impact associated with at least one trail persistent contrail of the flight, so that it same also taken into account to determine the score C of environmental impact of the flight.

In other words, when such optional supplement is implemented, the output of the second assembly E₂, namely, for each flight of the plurality, the impact of equivalent carbon dioxide associated with at least one persistent contrail of the flight is transmitted to the input of the third module 28 for determining a score C of environmental impact of each flight.

According to a variant, illustrated by FIG. 1, of such optional complement, the second assembly E₂ includes first of all, a fifth obtaining module 30 configured to obtain, at the input, a mapping of the geographical zones of formation of persistent contrails of the flight.

According to such variant, the second assembly E₂ further includes a module 32 for superimposing the mapping with the trajectory of the flight and for determining the length of persistent contrail(s) configured to be generated during the flight.

According to such variant, the second assembly E₂ further includes a sixth module 34 for obtaining the equivalent quantity of carbon dioxide CO_{2eq contrails} associated with at least one length of persistent contrail of the flight.

As illustrated in FIG. 1, as an optional supplement, the electronic device 10 for determining and providing a classification, according to the environmental impact thereof, of a plurality of distinct aeronautical flights also includes a seventh module 36 for obtaining a coefficient coeff_{ATC} representative of the difficulty of modifying said flight from the point of view of air traffic control, and/or an eighth module 38 for obtaining a coefficient coeffₐᵢᵣₗᵢₙₑ representative of the difficulty of modifying said flight from the point of view of the airline associated with said flight.

In other words, when the optional supplement is implemented, the output of said seventh obtaining module 36, namely, for each flight of the plurality, the coefficient coeff_{ATC} representative of the difficulty of modifying said flight from the point of view of air traffic control, and/or the output of said eighth obtaining module 38, namely, for each flight of the plurality, the coefficient representative of the difficulty of modifying said flight from the point of view of the airline associated with said flight, is/are transmitted at the input of the third module 28 for coeffₐᵢᵣₗᵢₙₑ determining a score C of environmental impact of each flight.

When the third module 28 for determining a score C of environmental impact of each flight is used in the most basic form thereof, said third module 28 for determining a score of environmental impact of each flight is then configured to use an equation in the following form:

$$C = \frac{{CO}_{2 eq NOx}}{{CO}_{2 eq ref citypairs}}$$

where CO_{2eq ref citypairs} is the average non-CO₂ environmental impact, in terms of nitrogen oxide emissions, of flights for each pair formed by the airport of departure and the airport of arrival of said flight.

When, in an improved manner, the input of said third module 28 for determining a score C of environmental impact of each flight is connected to the output of the second assembly E₂, and to the output of the aforementioned modules 36 and 38, said third module 28 for determining a score C of environmental impact of each flight is then configured to using an equation in the following form:

$$C = ( \frac{{CO}_{2 eq contrails} + {CO}_{2 eq NOx}}{{CO}_{2 eq ref citypairs}} ) * {coeff}_{ATC} * {coeff}_{airline}$$

where CO_{2eq ref citypairs} is the average of the non-CO₂ environmental impact, in terms of nitrogen oxide emissions and persistent contrail, of flights for each pair formed by the airport of departure and the airport of arrival of said flight.

Thereby, according to such optional supplement, as among the non-CO₂ effects, contrails and NOx nitrogen oxides emissions are at the origin of most of the “non-CO₂” consequences and because the knowledge thereof is mature enough not to have too many uncertainties in the results, it is proposed to focus on the two non-CO₂ effects in order to have a relevant view of the non-CO₂ emissions of a flight.

Optionally, said third module 28 for determining a score C of environmental impact of each flight is also configured to take into account the CO₂ emissions associated with each flight using an equation in the following form:

$$C = ( \frac{{CO}_{2} + {CO}_{2 eq contrails} + {CO}_{2 eq NOx}}{{CO}_{2 ref citypairs} + {CO}_{2 eq ref citypairs}} ) * {coeff}_{ATC} * {coeff}_{airline}$$

where CO_{2 ref citypairs} is the average of the environmental impact CO₂ of the flights for each pair formed by the airport of departure and the airport of arrival of said flight.

Regardless of whether or not the aforementioned optional additions are taken into account, the electronic device 10 according to the present invention includes a fourth determination module 40 configured to determine and provide a classification, according to the environmental impact thereof, of said plurality of distinct aeronautical flights, classified by decreasing value of said score C of environmental impact of each of said flights.

Said fourth determination module 40 is in particular apt to provide said classification by displaying on a screen of the electronic device 10, by sound reproduction, or else by transmission to another restitution device or system such as same of an air traffic control tower or same of an airline.

Optionally, the electronic device 10 further includes a module 42 for identifying the segment(s) of the trajectory having the maximum quantity or quantities of non-CO₂ emissions, or having the maximum quantity or quantities of CO₂ and non-CO₂ emissions.

In the example shown in FIG. 1, the electronic device 10 for determining and providing a classification includes an information processing unit 44 consisting, e.g., of a memory 46 and of a processor 48 associated with the memory 46.

In the example shown in FIG. 1, the first obtaining module 12, the second obtaining module 14, the discretization module 16, the first determination module 18, the second determination module 20, the third obtaining module 22, the fourth obtaining module 24, the conversion module 26, the third determination module 28, the fourth determination module 40, as well as, as an optional supplement, the fifth obtaining module 30, the superposition module 32, the sixth obtaining module 34, the seventh obtaining module 36, the eighth obtaining module 38 and the identification module 42, are each produced in the form of a software program or of a software brick which may be executed by the processor 48. The memory 46 of the electronic device 10 for determining and providing a classification is then apt to store a first obtaining software, a second obtaining software, a discretization software, a first determination software, a second determination software, a third obtaining software, a fourth obtaining software, a conversion software, a third determination software, a fourth determination software, as well as, optionally, a fifth obtaining software, a superposition software, a sixth obtaining software, a seventh obtaining software, an eighth obtaining software and an identification software. The processor is then apt to run each of the aforementioned software programs.

In a variant (not shown), the first obtaining module 12, the second obtaining module 14, the discretization module 16, the first determination module 18, the second determination module 20, the third obtaining module 22, the fourth obtaining module 24, the conversion module 26, the third determination module 28, the fourth determination module 40, as well as in optional addition the fifth obtaining module 30, the superposition module 32, the sixth obtaining module 34, the seventh obtaining module 36, the eighth obtaining module 38 and the identification module 42, are each produced in the form of a programmable logic component such as an FPGA (Field Programmable Gate Array) or else of an integrated circuit such as an ASIC (Application Specific Integrated Circuit).

When the electronic device 10 for determining and providing a classification is produced in the form of one or a plurality of software programs, i.e., in the form of a computer program, same is further apt for being recorded on a computer-readable medium (not shown). The computer-readable medium is, e.g., a medium apt to store the electronic instructions and to be coupled to a bus of a computer system. As an example, the readable medium is an optical disk, a magneto-optical disk, a ROM, a RAM, any type of non-volatile memory (e.g., FLASH or NVRAM) or a magnetic card. A computer program containing software instructions is then stored on the readable medium.

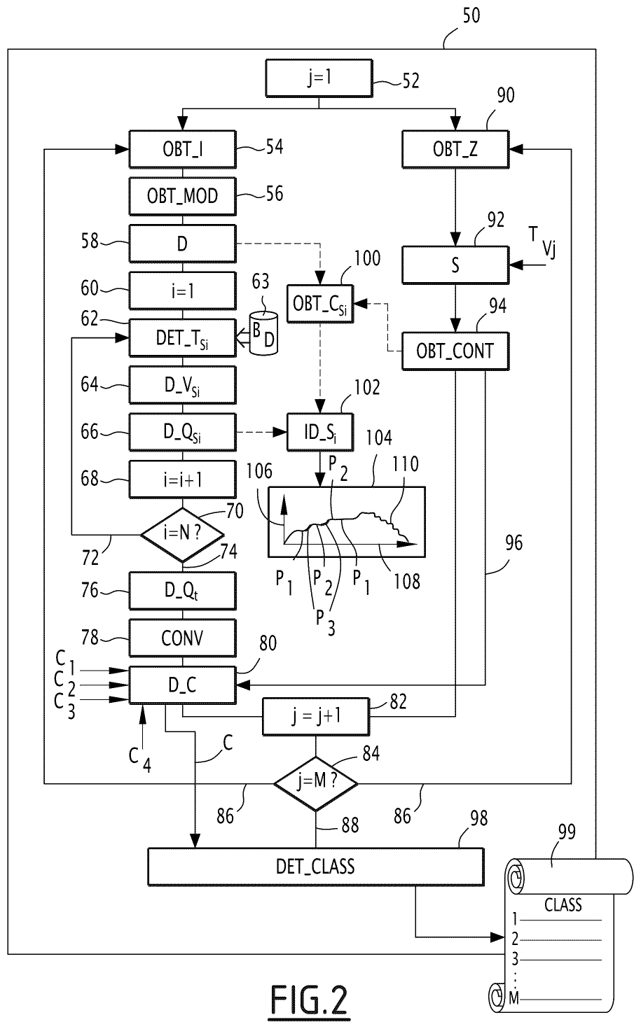

An example of the operation of said electronic device 10 for determining and providing a classification, according to the environmental impact thereof, of a plurality of distinct aeronautical flights is henceforth described hereinafter in relation to FIG. 2.

More precisely, it is considered thereafter that, according to the present invention, the method 50 for determining and providing a classification, according to the environmental impact thereof, is implemented for a plurality of distinct aeronautical flights including M distinct flights with M≥2, each flight being identified by an index j such that 1≤j≤M.

Said method 50 is thus partly iterative, the majority of the operations thereof being reiterated for each flight of index j.

According to an operation 52, j is initialized to one and the flight of index j=1 of the plurality of M distinct aeronautical flights is first of all processed.

To process the flight of index j=1, a first operation 54 of obtaining OBT_I of a priorly determined emission index of nitrogen oxides is implemented. Said index is a discrete variable including, depending upon the engine of the aircraft apt to perform said flight, four discrete values associated respectively with four distinct phases of flight, respectively, including the take-off, the climb, the approach, the idle. To this end, it is proposed, e.g., to use the “ICAO Aircraft Engine Emissions Databank” established in June 2023, published by the International Civil Aviation Organization (ICAO). Said free database contains the results of engine emission certification tests. Such tests are performed under four test conditions: take-off, climb-out, approach and idle. The four test conditions are described in Chapter III of the ICAO environmental Report 2022. Same correspond to thrust ratings from the maximum thrust.

Then, from said index, at least by linear regression, an operation 56 OBT_MOD of obtaining a model of emission of nitrogen oxides is implemented, said model of emission of nitrogen oxides being configured to provide the nitrogen oxide emission index EINOxᵣ associated with each triplet of types of input data including the engine thrust, the humidity and the atmospheric pressure.

In other words, such operation aims to enrich the current and partial knowledge of EINOx (only four points for each engine model) in order to generalize same to build an emission model configured to give an approximation of EINOx under all conditions.

On the one hand, as explained hereinabove, the classic EINOx depends on the type of engine and on the operating conditions thereof.

Herein, according to the present invention, it is advantageously proposed, in a non-obvious way, to represent by the thrust setpoint, the load demanded from an engine. Since each test condition corresponds to a percentage of maximum thrust, it is then possible to determine an empirical relationship between the thrust and the EINOx by performing a linear regression for each engine model from the four known points (thrust, EINOx) obtained during the preceding operation 54.

On each of the linear regressions performed according to the present invention on the 465 models of engine contained in the document (i.e., database) of the “ICAO Aircraft Engine Emissions Databank” mentioned hereinabove, an average error of 2.21 g_{NOX}/kg_{fuel consumed} is obtained, which corresponds to an average error of 13% which is very satisfactory given the difficulty of having a precise knowledge of the EINOx.

On the other hand, EINOx also depends on the atmospheric conditions under which the aircraft operates. In the ICAO Aircraft Engine Emissions Databank database, it is moreover proposed according to the present invention to access the minimum and maximum atmospheric pressure as well as the minimum and maximum humidity measured during each test, in order to apply, in addition, specifically according to the present invention, an altitude and humidity correction, in order to get as close as possible to the actual EINOx in flight.

For such a correction, it is proposed in particular to apply the teaching of D. Alejandro Block Novelo et al. indicated in the document entitled “On-board compressor water injection for civil aircraft emission reductions: Range performance with fuel burn analysis” of February 2019, and more particularly equation (6) in said document, to correct EINOx by taking into account weather conditions.

However, it should be noted that the correction disclosed by D. Alejandro Block Novelo et al. is applied within the aforementioned document from an emission index calculated from the temperature inside the compressor T_{b}, whereas the present invention proposes to apply the correction to the emission model obtained by linear regression and configured to give an EINOxᵣ approximation of EINOx under all conditions. According to the present invention, for such a correction, the average between the minimum and maximum measurement of humidity and pressure for each test (i.e., for each of the 465 models of engine contained in the CAO Aircraft Engine Emissions Databank database) is taken as reference meteorological conditions.

In parallel, previously, or, as illustrated by FIG. 2, successively during the aforementioned operations 54 and 56, an operation 58 of discretization D of the trajectory Tvⱼ associated with said flight of index j, into a plurality of trajectory segments, is implemented according to a predetermined time step constant from one flight to the other. For example, said plurality includes N segments with N≥2, each segment being identified by an index i such that 1≤i≤N.

Thereby, to determine the quantity of equivalent carbon dioxide CO_{2eqNOx} associated with the total quantity of nitrogen oxides emitted on each of said flights, the method according to the present invention includes a second iteration loop of index i of a trajectory segment nested in the first iteration loop of index j of each flight of said plurality of flights to be classified.

For each segment, the method 50 includes an operation 60 of initialization of the index i to one, followed by an operation 62 of determination (i.e., prediction) DET_TSᵢ of a triplet of input data including the engine thrust, the humidity and the atmospheric pressure associated with said segment of the trajectory of said flight of index j. In other words, the triplet of predicted data corresponds to the meteorological conditions predicted for the flight (in particular via weather models) as well as the engine thrust, associated with the segment of the flight considered, and determined from the trajectory by means of an existing aircraft model.

As an optional supplement, said triplet of input data of said segment is also determined from a priorly determined set of test data 63 (also called database B_{D}).

For example, the database 63 incudes at least the data of the aforementioned document “ICAO Aircraft Engine Emissions Databank” established in June 2023, published by the International Civil Aviation Organization (ICAO), which gathers the results of engine emission certification tests and contains the so-called reference meteorological conditions, since same are encountered during the tests.

Thereby, according to such optional supplement, during the operation 62 of determining DET_TSᵢ of a triplet of input data including engine thrust, humidity and atmospheric pressure associated with said segment of the trajectory of said flight of index j, it is proposed to access the average meteorological data on each trajectory segment in order to implement an altitude and humidity correction carried out by comparing the predicted data of the flight with the meteorological conditions measured during the test.

On the basis of said triplet of input data of said segment and said emission model of nitrogen oxides, the method further includes, for each segment, an operation 64 of determination D_VSᵢ of the associated value of the emission index of nitrogen oxides.

Then, using a model of predetermined fuel flow, said associated value of the emission index of nitrogen oxides and said time step, the method 50 includes an operation 66 of obtaining D_QSᵢ (i.e., determination) the quantity of nitrogen oxides emitted on said segment.

According to a variant, the model of predetermined fuel flow used according to the present invention is, e.g., the “Poll-Schumann” model, serving to determine the mean thrust and the fuel flow on each segment. By combining such information with said associated value of the NOx emission index, called EINOX(Thrust, humidity, pressure), and said time step, it is then possible to deduce the quantity QSi_{NOX} of NOx emitted on each segment of the discretized trajectory, in particular according to the following equation:

$${Q Si}_{NOX} = E I NO X ( Thrust , humidity , pressure ) * Fuel Flow * Time step$$

At the end of the aforementioned operations 62, 64, 66, according to an operation 68, the index I is incremented.

A test operation 70 is then implemented to determine whether or not all of the N segments of the flight path considered have been processed.

If the answer is negative, following arrow 72, the aforementioned operations 62, 64 and 66 are reiterated.

If the answer is affirmative, following arrow 74, the method then includes an operation 76 of obtaining D_Qₜ the total quantity of nitrogen oxides emitted on said flight, by summing the quantities of nitrogen oxides emitted on each segment of said plurality of segments composing said trajectory of said flight.

Then, according to an operation 78, the method 50 includes the conversion CONV of said total quantity of nitrogen oxides into an equivalent quantity of carbon dioxide CO_{2eqNOx}, using a predetermined global warming potential metric.

As an optional supplement, said predetermined metric of global warming potential is GWP100, as introduced in the study by Lee et al of 2021 entitled “The contribution of global aviation to anthropogenic climate forcing for 2000 to 2018” which gives access to coefficients for express an emission at the scale of CO₂ the coefficients being called GWP, the GWP100 applying over a period of 100 years which corresponds to the order of magnitude of the lifetime of the CO₂.

Regarding the choice of metrics, there is currently no consensus in the scientific community to compare non-CO₂ emissions with the different lifetimes thereof and the CO₂. According to such optional supplement, it is proposed to choose the GWP100 (GWP for Global Warming Potential) which is indeed at present the most mature metric and serves to compare emissions not having the same lifetimes which is essential with non-CO₂ effects. In addition, such metric has the advantage of serving to express the impacts at the scale of CO₂ by making an “equivalence in CO₂”, i.e., expressing an emission in quantity of CO₂that would induce the same consequences.

By using the GWP100, the method according to the present invention gains credibility since the GWP100 is a reference metric widely used in particular in climate policies (in particular by the Kyoto Protocol).

More precisely, said conversion 78 corresponds to the multiplication of said total quantity of nitrogen oxides obtained at the end of operation 76 by multiplying same by the constant GWP100 associated with nitrogen oxide emissions indicated in the aforementioned study by Lee et al of 2021.

Then, at least on the basis of said quantity of equivalent carbon dioxide CO_{2eqNOx} associated with the total quantity of nitrogen oxides emitted on said flight, the method includes an operation 80 of determination D_C of a score C of environmental impact of said flight.

According to a first variant, in the most basic form thereof, said score C of environmental impact of each flight is determined using the equation in the following form:

$$C = \frac{{CO}_{2 eq NOx}}{{CO}_{2 eq ref citypairs}}$$

where CO_{2eq ref citypairs} is the average non-CO₂ environmental impact, in terms of nitrogen oxide emissions, of flights for each pair formed by the airport of departure and the airport of arrival of said flight. The coefficient CO_{2eq ref citypairs} is defined by statistical analysis from a database of flights carried out. The coefficient CO_{2eq ref citypairs} makes it possible to compare (via the score C) flights of various nature by normalizing the score C by the emissions that are emitted on said route on in a recurrent way. Without dividing by said coefficient (i.e., without normalizing), one would often find that a Paris-New York flight would be more problematic than a Toulouse-Paris flight since more would be emitted on the first route (longer route with a different aircraft).

Other variants of calculation of the score C will be described thereafter depending on the implementation of optional operations.

At the end of the aforementioned operations, according to an operation 82, the index j is incremented.

A test operation 84 is then implemented to determine whether or not all of the N segments of the flight path considered have been processed.

If the answer is negative, following arrow 86, the aforementioned operations are reiterated.

If the answer is affirmative, following arrow 88, the determination and provision of classification is implemented as subsequently described.

Indeed, optionally according to the example of embodiment shown in FIG. 1, as in FIG. 2, in parallel with the aforementioned operations, the method 50 also includes the determination of the equivalent carbon dioxide impact associated with at least one persistent contrail of said flight, and taking same into account for determining said score of environmental impact of said flight.

Such a determination includes, for each flight (i.e., first iteration loop of index j of each flight) according to a variant, the optional operations 90, 92 and 94.

During the optional operation 90, the method includes obtaining OBT_Z, at the input, a mapping of the geographical zones of formation of persistent contrails of said flight.

Indeed, in order to estimate the environmental impact of persistent contrails, it is essential to know how to quantify the quantity of persistent contrails created. To this end, it is necessary to map the zones conducive to the generation of persistent contrails. The above concerns zones where an aircraft flying indoors is likely to generate persistent contrails.

To this end, there is a certain consensus to locate the zones according to two criteria, namely, on the one hand, the Schmidt-Appleman criterion (SAC) which serves to determine the wet and cold zones where aircraft may generate contrails by condensation of water vapor. Nevertheless, only persistent contrails have a significant impact on global warming, which is why there is, on the other hand, a second criterion, the Ice Super-Saturated Regions (ISSR), according to which for a contrail to persist and have a significant climatic impact, same has to be formed in an ice saturated region. Thereof is characterized by an ice relative humidity RH_{ice} greater than 100% (

$$R {H}_{i c e} = \frac{e}{{e}_{i c e}} \geq 100 \%$$

where e represents the water vapor pressure and e_{ice} the ice saturation pressure).

According to another example, there are also python libraries for mapping such zones of formation of persistent contrails by estimating from meteorological data whether persistent contrails are present or not, such as the PyContrails tool the output (i.e., indicating the presence or not of persistent contrails) of which is used as an input to operation 90.

Then, in the optional operation 92, the method 50 includes the superposition S of said mapping with the trajectory Tvⱼ of said flight of index j considered and determination of the length of persistent contrail(s) configured to be generated during said flight.

In the optional operation 94, the method 50 includes obtaining OBT_CONT the quantity 96 of equivalent carbon dioxide CO_{2eq contrails} associated with at least one length of persistent contrail of said flight of index j, in particular using the coefficient GWP100 expressed according to the length of persistent contrail generated in order to have the equivalent impact of carbon dioxide CO_{2eq contrails}.

According to such option, the quantity 96 of equivalent carbon dioxide CO_{2eq contrails} is then taken into account, such as an input, during the abovementioned operation 80 of determination D_C of a score C of the environmental impact of said flight.

According to another optional addition, the aforementioned operation 80 of determination D_C of a score C of environmental impact of said flight also takes into account at least one of the following coefficients:
a coefficient C₁=coeff_{ATC} representative of the difficulty of modifying said flight from the point of view of air traffic control, with C₁ included between zero and one;
a coefficient C₂=coeffₐᵢᵣₗᵢₙₑ representative of the difficulty of modifying said flight from the point of view of the airline associated with said flight, with C₂ included between zero and one.

Thereby, when such consideration is implemented, in an improved manner, the aforementioned operation 80 of determination D_C of a score C of environmental impact of said flight has, at the same time, as inputs:
the equivalent quantity of carbon dioxide CO_{2eqNOx} coming from the conversion operation 78;
the quantity of equivalent carbon dioxide CO_{2eq contrails} associated with at least one length of persistent contrail of said flight coming from the optional operation 94;
the coefficient C₁=coeff_{ATC} representative of the difficulty of modifying said flight from the point of view of air traffic control;
the coefficient C₂=coeffₐᵢᵣₗᵢₙₑ representative of the difficulty of modifying said flight from the point of view of the airline associated with said flight;
   and the determination of a score C of environmental impact for each flight is then configured to use an equation in the following form:

$$C = ( \frac{{CO}_{2 eq contrails} + {CO}_{2 eq NOx}}{{CO}_{2 eq ref citypairs}} ) * {coeff}_{ATC} * {coeff}_{airline}$$

where CO_{2eq ref citypairs} is the average of the non-CO₂ environmental impact of the flights for each pair formed by the airport of departure and the airport of arrival of said flight, multiplying by the two coefficients coeff_{ATC} ∈[0,1] and coeffₐᵢᵣₗᵢₙₑ∈[0,1] being configured to reduce the importance of a flight so that same will not be treated first by the airline since same would appear later (i.e., classified lower) in the decreasing classification of flights classified according to the score C of the flight with the most environmental impact to the flight with the flight with the least impact.

As an optional supplement, the aforementioned operation 80 of determination D_C of a score C of environmental impact of said flight also takes into account two other variables C₃ and C₄ for taking into account the CO₂ emissions associated with said flight using an equation in the following form:

$$C = ( \frac{{CO}_{2} + {CO}_{2 eq contrails} + {CO}_{2 eq NOx}}{{CO}_{2 ref citypairs} + {CO}_{2 eq ref citypairs}} ) * {coeff}_{ATC} * {coeff}_{airline}$$

where C₃=CO₂ the CO₂ emissions associated with said flight using a constant multiplier EICO2=3.16 kg_{CO2}/kg_{fuel} set by the International Civil Aviation Organization (ICAO) such as CO₂=3.16*Qt_{f}) with Qt_{f} the quantity of fuel burned as used in the ICAO Environmental Report 2022 and in the ICAO Carbon Emissions Calculator Methodology.
and C₄=CO_{2 ref citypairs} is the average of the environmental impact CO₂ of the flights for each pair formed by the airport of departure and the airport of arrival of said flight.

Indeed, considering only the non-CO₂ effects, it is possible to be in a situation where a flight is modified in order to reduce non-CO₂ emissions, but which in return consumes more fuel, hence emits more CO₂ and which, considering the overall environmental impact, would be worse than the initial trajectory.

Such problematic situation is unfortunately possible, as described by E. Roosenbrand et al. in the document entitled “Contrail minimization through altitude diversions: A feasibility study leveraging global data” of 2023, where it is indicated that in 63% of cases a modification of the trajectory to prevent a zone of contrail, the closest solution is to reduce altitude which leads to a reduction in energy efficiency (fuel efficiency) thereby an increase in fuel consumption, CO₂ emissions and potentially NOx.

Similarly, according to the 2018 study by S. Freeman et al. entitled “Trading off aircraft fuel burn and NOx emissions for optimal Climate Policy”, a 20% reduction in NOx emissions results in a 2% increase in the quantity of CO₂emitted. Trade-off CO₂/non-CO₂ is thus essential for a more sustainable aviation.

Thereby, by considering an “equivalence in CO₂”, the method according to the present invention participates in anticipating the future problem of compromise CO₂/non-CO₂ effects which will be all the more important with the integration of non-CO₂ effects in carbon taxation systems, by grouping together and comparing several types of non-CO₂ emissions (i.e., emission of nitrogen oxides and non-CO₂ emission associated with persistent contrails), and furthermore by integrating operational difficulties via coefficients coeff_{ATC} and/or coeffₐᵢᵣₗᵢₙₑ.

It should be noted that according to the aforementioned optional supplement, the choice of GWP100 makes it possible to compare each of the effects considered: emission of nitrogen oxides NOx, emissions associated with persistent contrails and carbon dioxide CO₂ as such, over the entire lifetime thereof and thus consider the overall impact thereof for reducing the ecological footprint of the flight in an overall way.

The choice of GWP100 also makes it possible to directly determine the environmental impact of a flight from the length of persistent contrails generated and the quantity of nitrogen oxides NOx emitted, as well as express the “no-CO₂” climate impact in a term CO_{2eq} which is very useful thereafter for the implementation of a CO₂/non-CO₂ trade-off since all emissions are “on the same scale”.

At the end of each iteration of the first iteration loop of index j, the score C of each flight of index j is transmitted for storage at the input of operation 98 of determining and providing the classification 99, according to the environmental impact thereof, of the plurality of M distinct aeronautical flights, the flight having the greatest environmental impact (i.e., the highest score C and hence the most problematic flight) being classified first.

As an optional supplement, the method 50 according to the present invention further includes an operation 100 for obtaining OBT_Cₛᵢ of the equivalent quantity of carbon dioxide associated with at least one length of persistent contrail of said flight for each segment considered resulting from the discretization operation. Such a quantity per trajectory segment is obtained in particular by superimposing the mapping of the geographical zones of formation of persistent contrails of the flight with each of said segments for determining the length (i.e., the size) of the contrail on each segment considered.

Said quantity, per segment, of equivalent carbon dioxide associated with at least one length of persistent contrail, as well as the quantity, per segment, of nitrogen oxides emitted, are then supplied at the input of an operation 102 of identification ID-Si of the segment(s) of the trajectory having the maximum quantity or quantities of non-CO₂ emission, or having the maximum quantity or quantities of CO₂ and non-CO₂ emission.

More precisely, for each segment, the quantity of non-CO₂ emission is equal to the sum of, on the one hand, the quantity of nitrogen oxides emitted on said segment converted into an equivalent carbon dioxide quantity CO_{2eqNOx}, using said predetermined global warming potential metric, and, on the other hand, the equivalent carbon dioxide quantity associated with at least one length of persistent contrail of said flight for said segment considered.

To this end, e.g., the following equation is used for each segment:

$${CO}_{2 eq} / s = G WP {100}_{NOx} * {E I NO x}_{r} * Fuel Flow + G WP {100}_{contrails} * G S * {1}_{contrails}$$

where:
CO_{2eq}/s: corresponds to the average equivalent carbon dioxide emission rate CO_{2eq} (in kilogram per second, kg/s) over each segment of trajectory (a segment being a portion of the trajectory discretized according to a constant time step as performed during operation 58);
GWP100_{NOx} and GWP100 contrails are constants set by the study by Lee et al of 2021 that compare the importance of a non-CO₂ emission with the impact of a CO₂ emission.
EINOxᵣ: the emission index provided by the model of emission of nitrogen oxides obtained by linear regression and optionally by altitude and humidity correction according to the present invention, i.e., the quantity of nitrogen oxides NOx emitted per quantity of fuel consumed;
Fuel flow: the flow-rate of fuel consumed determined using a model such as the Poll-Schumann model;
GS: The ground speed of the aircraft, i.e., the speed of the aircraft corrected by the wind;
1_{contrails}: the indicator function which is “1” when one is in a zone a conducive to the formation of persistent contrails and “0” otherwise. The indicator function is determined using the mapping of contrails, generated, e.g., by the aforementioned PyContrails tool and takes as input the position of the aircraft in terms of longitude, latitude, altitude.

Optionally, the quantity of CO₂ emission likely to be emitted during the same trajectory segment considered is associated with the quantity of non-CO₂ emission specific to each segment.

To this end, e.g., the following equation is then used for each segment:

$$\frac{{CO}_{2}}{s} + {CO}_{2 eq} / s = 3.16 * Fuel Flow + G WP {100}_{NOx} * {E I NO x}_{r} * Fuel Flow + G WP {100}_{contrails} * G S * {1}_{contrails}$$

where:
CO₂/S=3.16*Fuel Flow: corresponds to the average carbon dioxide emission rate (in kilogram per second, kg/s) over each segment of trajectory.

Still according to such optional supplement, according to an operation 104, a representation of the flight, in the form of the trajectory segments thereof, is generated in order to enable a user to identify more easily, in particular visually by displaying on a screen, the segments of the flight which have the most environmental impact.

According to the example shown in FIG. 2, such a representation is two-dimensional with the altitude on the ordinate 106 and the distance traveled on the abscissa 108, the trajectory 110 being represented in the form of a broken line formed by a plurality of segments. In such representation, a color code is used to represent the most problematic segments in terms of environmental impact. For example, the segments P₁ are represented in yellow and [are] representative of the exceeding of a first environmental impact threshold, the P₂ segments are represented in orange and [are] representative of the exceeding of a second threshold higher than the first threshold, and the P₃ segments are represented in red and [are] representative of the exceeding of a third threshold higher than the second threshold. In other words, the P₃ segments are the segments identified as the most problematic in terms of environmental impact.

Thereby, the present invention proposes a tool, e.g., to an airline, which would enable same to view for each flight, the most emitting portions of trajectory in order to choose to optimize not the entire flight but only the critical portions in order to limit the operational disturbances generated by the modification.

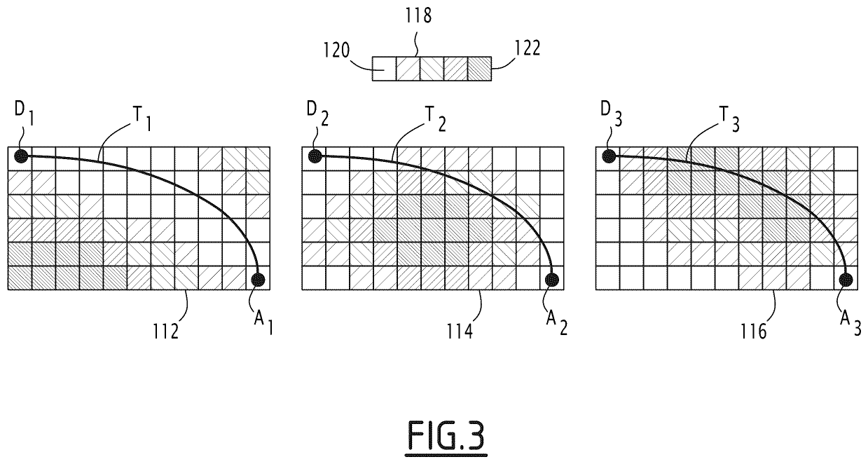

FIG. 3 illustrates the change, as a function of traffic density, of the coefficient representative of the difficulty of modifying a flight from the point of view of air traffic control, used according to the present invention to participate in the classification of flights, and avoid studying a potential modification of the flight that could not be carried out concretely in flight.

Indeed, it may be that a very emitting flight may be difficult to modify because same flies through airspaces where traffic is dense, with strict ATC (Air Traffic Control) requirements, which makes a modification of the trajectory impossible.

More precisely, the representation 112 is associated with a coefficient coeff_{ATC} representative of the difficulty of modifying said flight from the point of view of an air traffic control, the value of which is equal to one, the representation 114 is associated with a value strictly included between 0 and 1 (i.e., strictly less than one and strictly greater than zero), whereas the representation 116 is associated with a zero value of the coefficient.

The traffic density is represented using a texture scale 118, the white 120 being representative of an airspace with a low traffic density, whereas the most densely hatched texture 122 is representative of an airspace saturated by traffic.

In the representation 112, the flight considered along the trajectory T₁ has a departure D₁ and an arrival A₁. The representation 112 illustrates that the flight considered takes place in spaces where the air traffic is not very dense, so that same is associated with a coefficient coeff_{ATC} the value of which is equal to one meaning that it is less difficult to modify same from the point of view of the air traffic control.

In the representation 114, the flight considered along the trajectory T₂ has a departure D₂ and an arrival A₂. The representation 114 illustrates that the flight considered takes place in spaces where the air traffic is dense in the vicinity, which corresponds to a coefficient value coeff_{ATC} strictly included between 0 and 1.

Finally, in the representation 116, the flight considered along the trajectory T₃ has the departure D₃ and the arrival A₃. The representation 116 illustrates that the flight in question takes place in spaces saturated by the air traffic, so that it is associated with a coefficient coeff_{ATC} the value of which is zero, meaning that it is impossible to modify the trajectory thereof from the point of view of the air traffic control.

The aforementioned coefficient C₂=coeffₐᵢᵣₗᵢₙₑ representative of the difficulty of modifying the flight from the point of view of the airline associated with the flight is also includes between 0 and 1 and is intended to avoid studying a potential modification of flight trajectory that could not be carried out in flight from the point of view of the airline operating same.

Indeed, a very emitting flight may be difficult to modify because the latter makes a very short connection at the destination airport (i.e., hub) and a possible modification of the flight could lead to a delay threatening flights or to additional traffic costs.

For example, if C₂=coeffₐᵢᵣₗᵢₙₑ=1, thereof means (i.e., represents) that a possible delay due to a modification of the flight trajectory is not penalizing for the airline. The flight is not involved in any connections and does not transport customers with high demands (business or first class customers).

If 0<C₂=coeffₐᵢᵣₗᵢₙₑ<1, thereof means that a possible delay due to a modification of the flight may be penalizing to a variable extent for the airline since same could disrupt other flights or degrade the image of the airline.

Finally, if C₂=coeffₐᵢᵣₗᵢₙₑ=0, thereof means that a possible delay due to a modification of the flight is inconceivable because the impact thereof would have serious consequences for the company. The flight should thus not be modified.

In other words, the coefficients coeff_{ATC} and coeffₐᵢᵣₗᵢₙₑ are used as weighting coefficients to downgrade a flight in the classification according to criterion C when the modification of the trajectory thereof is not desirable from the point of view of the air traffic control ATC or from the point of view of the airline.

A person skilled in the art would understand that the invention is not limited to the embodiments described, nor to the particular examples of the description, the above-mentioned embodiments and variants being configured to be combined with one another so as to generate new embodiments of the invention.

The present invention thereby makes it possible to develop an indicator serving to identify flights having non-negligible non-CO₂ effects, in particular in terms of emissions of nitrogen oxides NOx, and optionally of emissions associated with persistent contrails, and also as an optional supplement by integrating possible operational difficulties (for airlines or for air traffic controllers), and is included upstream of any optimization of trajectory as such, so that, such as a filter, to make it possible to focus on another flight by considering the emissions of nitrogen oxides NOx, or even at the same time with missions associated with persistent contrails, while integrating operational considerations such as the point of view of the airlines or of the air traffic controllers.

Thereby, the present invention proposes a classification to be used to filter, e.g., the flight plans submitted by an airline, in order to subsequently optimize only the flights for which optimization would be possible and interesting for the environment and optionally for the airline.

Indeed, the present invention proposes a generic method that groups together the different non-CO₂ emissions in order to have a global vision of the non-CO₂ environmental impact of a flight and that makes it possible to identify the problematic flights to be treated and makes it possible to consider such non-CO₂ emissions equal to the CO₂. Emissions.

It is thus proposed to favor the identification of problematic flights prior to the modifications thereof in order to make same more sustainable, which makes it possible to use the fact that only a small percentage of flights generate the majority of non-CO₂ emissions from the sector.

By choosing the predominant effects the uncertainties of which are reasonable, the operators' confidence in the indicator is enhanced, which leads to adding in non-CO₂ effects into the considerations thereof.

Furthermore, optionally, for each flight, an identification of problematic portions of trajectory is proposed according to the present invention in order to optimize only one or a plurality of portions of the flight.

1. A method for determining and providing a classification, according to the environmental impact thereof, of a plurality of distinct aeronautical flights, the method being implemented by an electronic device, and comprising:
for each aeronautical flight:
obtaining a previously determined index of nitrogen oxide emission, the index being a discrete variable including, depending upon the engine of the aircraft configured to carry out the aeronautical flight, four discrete values associated with four distinct phases of flight, respectively, including take-off, climb, approach and idle;
from the index, at least by linear regression, obtaining a model of emission of nitrogen oxides, the model providing the nitrogen oxide emission index associated with each triplet of types of input data including engine thrust, humidity and atmospheric pressure; and
discretizing the trajectory associated with the flight, according to a predetermined constant time step, into a plurality of trajectory segments;
for each segment:
determining a triplet of input data including engine thrust, humidity and atmospheric pressure associated with the segment;
on the basis of the triplet of input data triplet of the segment and of the model of emission of nitrogen oxides, determining the associated value of the emission index of nitrogen oxides; and
using a model of predetermined fuel flow, the associated value of the emission index of nitrogen oxides, and the time step, obtaining the quantity of nitrogen oxides emitted on the segment;
obtaining the total quantity of nitrogen oxides emitted on the aeronautical flight, comprising summing the quantities of nitrogen oxides emitted on each segment of the plurality of segments composing the trajectory of the flight;
converting the total quantity of nitrogen oxides into equivalent carbon dioxide using a predetermined metric of global warming potential;
determining a score of environmental impact of the aeronautical flight, at least on the basis of the quantity of equivalent carbon dioxide associated with the total quantity of nitrogen oxides emitted on the aeronautical flight; and
determining and providing a classification, according to the environmental impact thereof, of the plurality of distinct aeronautical flights, classified by decreasing value of the score of environmental impact of each of the flights.

2. The method according to claim 1, wherein the predetermined global warming potential metric is GWP100.

3. The method according to claim 1, wherein the triplet of input data of the segment is determined from a set of priorly determined test data.

4. The method according to claim 1, further comprising, for each aeronautical flight, determining an equivalent carbon dioxide impact associated with at least one persistent contrail of the aeronautical flight, and taking same into account for determining the score of environmental impact of the flight.

5. The method according to claim 4, wherein said determining the equivalent carbon dioxide impact comprises:
obtaining, at the input, a mapping of geographical zones of formation of persistent contrails of the flight;
superposing the mapping with the trajectory of the aeronautical flight and determining the length of persistent contrail(s) likely to be generated during the aeronautical flight; and
obtaining an equivalent quantity of carbon dioxide associated with at least one length of persistent contrail of the aeronautical flight.

6. The method according to claim 1, wherein the score of environmental impact of each of the aeronautical flights also takes into account at least one of the following coefficients:
a coefficient representative of the difficulty of modifying the flight from the point of view of air traffic control; and
a coefficient representative of the difficulty of modifying the flight from the point of view of the airline associated with the flight.

7. The method according to claim 6, wherein the score is obtained using an equation in the form of:
$$C = ( \frac{{CO}_{2 eq contrails} + {CO}_{2 eq NOx}}{{CO}_{2 eq ref citypairs}} ) * {coeff}_{ATC} * {coeff}_{airline}$$
where:
C is the score,
coeff_{ATC} is the coefficient representative of the difficulty of modifying the flight from the point of view of air traffic control,
coeffₐᵢᵣₗᵢₙₑ is the coefficient representative of the difficulty of modifying the flight from the point of view of the airline associated with the flight CO_{2eq NOx} is the quantity of equivalent carbon dioxide associated with the total quantity of nitrogen oxides emitted on the flight,
CO_{2eq contrails} is the equivalent quantity of carbon dioxide associated with at least one length of persistent contrail of the flight, and
CO_{2eq ref citypairs} is the average of the non-CO₂ environmental impact, in terms of nitrogen oxide emissions and persistent contrail, of flights for each pair formed by the airport of departure and the airport of arrival of the flight.

8. The method according to claim 6, wherein the score takes into account the CO₂ emissions associated with the flight using an equation of the following form:
$$C = ( \frac{{CO}_{2} + {CO}_{2 eq contrails} + {CO}_{2 eq NOx}}{{CO}_{2 ref citypairs} + {CO}_{2 eq ref citypairs}} ) * {coeff}_{ATC} * {coeff}_{airline}$$
where:
C is the score,
coeff_{ATC} is the coefficient representative of the difficulty of modifying the flight from the point of view of air traffic control,
coeffₐᵢᵣₗᵢₙₑ is the coefficient representative of the difficulty of modifying the flight from the point of view of the airline associated with the flight CO_{2eq NOx} is the quantity of equivalent carbon dioxide associated with the total quantity of nitrogen oxides emitted on the flight,
CO_{2eq contrails} is the equivalent quantity of carbon dioxide associated with at least one length of persistent contrail of the flight, and
CO_{2 ref citypairs} is the average of the environmental impact CO₂ of the flights for each pair formed by the airport of departure and the airport of arrival of the flight, and
CO_{2eq ref citypairs} is the average of the non-CO₂ environmental impact, in terms of nitrogen oxide emissions and persistent contrail, of flights for each pair formed by the airport of departure and the airport of arrival of the flight.

9. The method according to claim 1, further comprising, for each aeronautical flight, or for a predetermined number of aeronautical flights of the classification, identifying the segment or segments of the trajectory having the maximum quantity or quantities of non-CO₂ emission or having the maximum quantity or quantities of CO₂ and non-CO₂ emission.

10. An electronic device for determining and providing a classification, according to the environmental impact thereof, of a plurality of distinct aeronautical flights, the device comprising at least:
for each aeronautical flight:
a first retriever obtaining a previously determined index of nitrogen oxide emission, the index being a discrete variable comprising, depending upon the engine of the aircraft configured to carry out the aeronautical flight, four discrete values associated with four distinct phases of flight, respectively, comprising take-off, climb, approach and idle;
a second retriever obtaining, from the index, at least by linear regression, a model of emission of nitrogen oxides, the model providing the nitrogen oxide emission index associated with each triplet of types of input data comprising engine thrust, humidity and atmospheric pressure;
a discretizer discretizing the trajectory associated with the aeronautical flight, according to a predetermined constant time step, into a plurality of trajectory segments;
a first calculator determining, for each segment, a triplet of input data including the engine thrust, the relative humidity and the atmospheric pressure associated with the segment;
a second calculator determining, for each segment, on the basis of the triplet of input data triplet of the segment and of the model of emission of nitrogen oxides, the associated value of the emission index of nitrogen oxides;
a generator obtaining, for each segment, the quantity of nitrogen oxides emitted on the segment, using a model of predetermined fuel flow, the associated value of emission index of nitrogen oxides, and the time step;
a third retriever obtaining the total quantity of nitrogen oxides emitted on the aeronautical flight, by summing the quantities of nitrogen oxides emitted on each segment of the plurality of segments composing the trajectory of the aeronautical flight;
a convertor converting the total quantity of nitrogen oxides to equivalent carbon dioxide, using a predetermined global warming potential metric; and
a third calculator determining, at least on the basis of the quantity of equivalent carbon dioxide associated with the total quantity of nitrogen oxides emitted on the aeronautical flight, a score of environmental impact of the aeronautical flight; and
a fourth calculator determining and provide a classification, according to the environmental impact thereof, of the plurality of distinct aeronautical flights, classified by decreasing value of the score of environmental impact of each of the aeronautical flights.
